(19) United States
(12) Patent Application Publication
(10) Pub. No.: US 2015/0159558 A1
(43) Pub. Date: Jun. 11, 2015

(54) Method And System For Dispensing Gas Turbine Anticorrosion Fluid

(71) Applicant: General Electric Company, Schenectady, NY (US)

(72) Inventors: Alston Ilford Scipio, Mableton, GA (US); Douglas S. Byrd, Greer, SC (US); Dale J. Davis, Greenville, SC (US); Sanji Ekanayake, Mableton, GA (US)

(73) Assignee: General Electric Company, Schenectady, NY (US)

(21) Appl. No.: 14/099,217

(22) Filed: Dec. 6, 2013

(51) Int. Cl. F02C 7/30

(52) U.S. Cl. CPC F02C 7/30; F05D 2260/95

(57) ABSTRACT

Disclosed herein are methods and systems for dispensing turbine engine anticorrosive protection. In an embodiment, a method may include selecting an anticorrosion fluid for a gas turbine engine and applying the anticorrosion fluid to the gas turbine engine.

### BACKGROUND OF THE INVENTION

A compressor of a gas turbine engine may be exposed to dust ingestion and entry of an occasional dislodged foreign object that bypasses the inlet and results in varying degree of impact damage (e.g., corrosion, tip erosion/rubs, trailing edge thinning and stator root erosion). A gas turbine engine also has blades and other structures of a turbine that are subject over time to the buildup of deposits of various residues that are byproducts of the combustion process. Impact damage and deposit build up results in loss of turbine efficiency and potential degradation of gas turbine engine components.

### BRIEF DESCRIPTION OF THE INVENTION

Disclosed herein are methods and systems for dispensing turbine engine anticorrosive protection. In an embodiment, a method includes selecting an anticorrosion fluid for a gas turbine engine and applying the anticorrosion fluid to the gas turbine engine.

In an embodiment, a system includes a turbine engine, a pipe in fluid communication with the turbine engine, a valve connected with the pipe, a source of an anticorrosion fluid in fluid communication with the pipe, a sensor located on or near the turbine engine, and a control system communicatively connected with the sensor and the valve.

In an embodiment, a system may include a processor adapted to execute computer-readable instructions and a memory communicatively coupled to the processor. The memory may have stored therein computer-readable instructions that, if executed by the processor, cause the processor to perform operations including determining a condition of a gas turbine engine, determining an anticorrosion fluid for the gas turbine engine based on the condition, and providing instructions to apply the anticorrosion fluid to the gas turbine engine.

This Brief Description of the Invention is provided to introduce a selection of concepts in a simplified form that are further described below in the Detailed Description. This Brief Description of the Invention is not intended to identify key features or essential features of the claimed subject matter, nor is it intended to be used to limit the scope of the claimed subject matter. Furthermore, the claimed subject matter is not limited to limitations that solve any or all disadvantages noted in any part of this disclosure.

### BRIEF DESCRIPTION OF THE DRAWINGS

A more detailed understanding may be had from the following description, given by way of example in conjunction with the accompanying drawings wherein:

FIG. 1 is an exemplary illustration of a power plant system;

FIG. 2 is a sectional view of a gas turbine engine including turbine and compressor piping;

FIG. 3 is a schematic illustration of an exemplary system for dispensing a fluid for treating a gas turbine engine;

FIG. 4 illustrates a non-limiting, exemplary method of applying a gas turbine engine anticorrosive treatment;

FIG. 5 is an exemplary block diagram representing a general purpose computer system in which aspects of the methods and systems disclosed herein or portions thereof may be incorporated.

### DETAILED DESCRIPTION OF THE INVENTION

Compressors of gas turbine engines operating in harsh environments may have foreign object damage, corrosion, tip erosion/rubs, trailing edge thinning, and stator root erosion. Blending, polishing, and grinding may be utilized during outages to mitigate the rate of corrosion and further propagation of other damage. Blending has applicability and limitations in that it cannot be used to mitigate or resurface pits and craters, which in most instances if left untreated can lead to crack prorogation and accelerated corrosion.

Disclosed herein are methods and systems for the application of gas turbine engine anticorrosion fluid, such as a polyamine based fluid. As used herein, the term “polyamine” is used to refer to an organic compound having two or more primary amino groups —NH2. In an embodiment, an anticorrosion agent may comprise a volatile neutralizing amine which neutralizes acidic contaminants and elevates the pH into an alkaline range, and with which protective metal oxide coatings are particularly stable and adherent. Non-limiting examples of the anticorrosion agent include cycloheaxylamine, morpholine, monoethanolamine, N-9-Octadecenyl-1,3-propanediamine, 9-octadecen-1-amine, (Z)-1-5, dimethylaminepropylamine (DMPA), diethylaminoethanol (DEAE), and the like, and a combination comprising at least one of the aforementioned. For example, anticorrosion fluid may include a combination of a polyamine (a multifunction organic amine corrosion inhibitor) and neutralizing amines (volatile organic amines).

In an embodiment, existing compressor bellmouth injection nozzles and modified compressor air extraction and turbine nozzle cooling air piping ports may be used as a means to disperse an anticorrosion fluid. An aerosolized anticorrosion fluid may be generated from a mixture of an anticorrosion agent and water, into the bellmouth, fore and aft stages of the compressor, or into the turbine section. The injection of the aerosolized anticorrosive fluid into both the compressor and turbine section may occur simultaneously or sequentially. In addition, because of the different material composition and coatings in the turbine and compressor sections, different ratio blends of the anticorrosive fluid may be introduced into the compressor and turbine sections by varying the valve alignment.

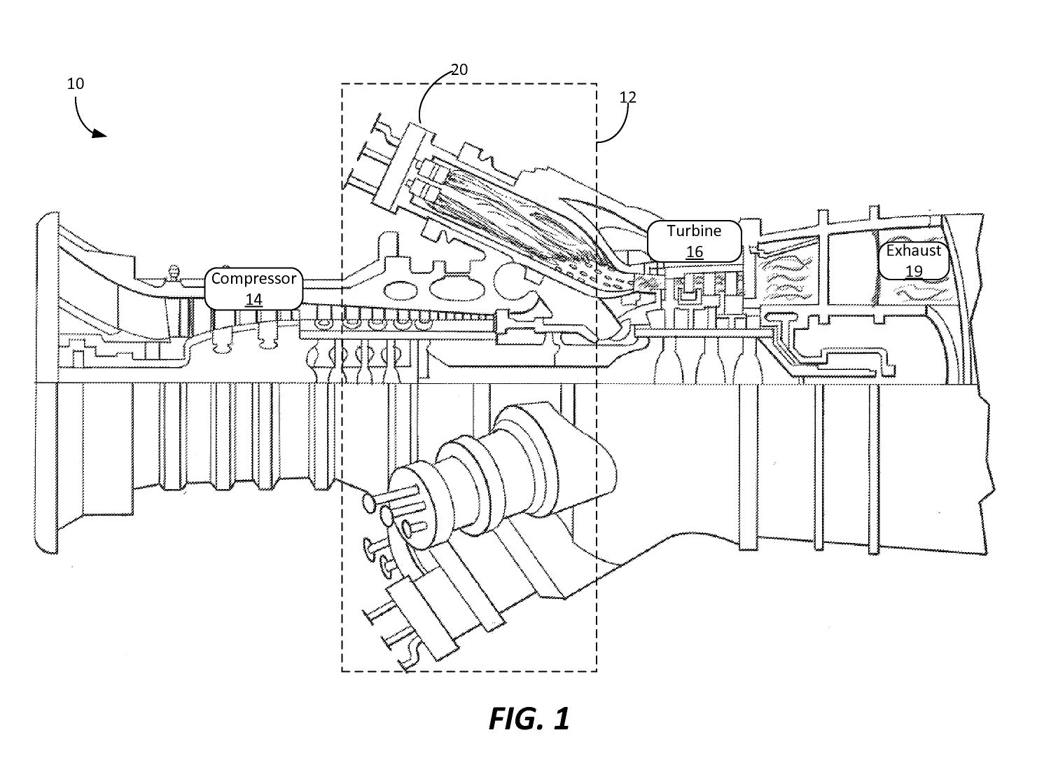

FIG. 1 is an exemplary illustration of a partial cross section of a gas turbine engine 10 in which anticorrosion fluid may be applied. As shown in FIG. 1, gas turbine engine 10 has a combustion section 12 in a gas flow path between a compressor 14 and a turbine 16. The combustion section 12 may include an annular array of combustion components around the annulus. The combustion components may include combustion chamber 20 and attached fuel nozzles. The turbine 16 is coupled to rotationally drive the compressor 14 and a power output drive shaft. Air enters the gas turbine engine 10 and passes through the compressor 14. High pressure air from the compressor 14 enters the combustion section 12 where it is mixed with fuel and burned. High energy combustion gases exit the combustion section 12 to power the turbine 16 which, in turn, drives the compressor 14 and the output power shaft. The combustion gases exit the turbine 16 through the exhaust duct 19 and may enter into a heat recovery steam generator (HRSG) to extract additional energy from the exhaust gas.

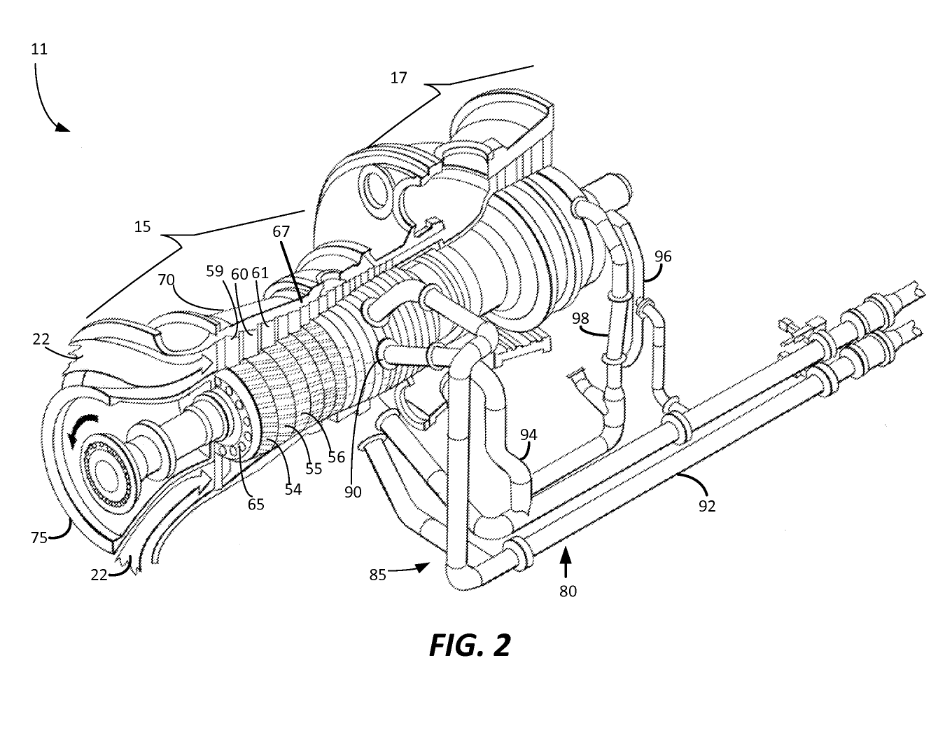

FIG. 2 is an exemplary illustration of a gas turbine engine 11 that includes cooling and sealing air valve and pipe components. Compressor 15 may include a number of stages. As shown in FIG. 2, there may be an A-stage 54, a B-stage 55, or C-stage 56 of the compressor. The terms “A-stage”, “X-stage”, and the like are used herein as opposed to “first stage”, “second stage,” and the like so as to prevent an inference that the systems and methods described herein are in any way limited to use with the actual first stage or the second stage of the compressor or the turbine. Any number of the stages may be used. Each stage includes a number of circumferentially arranged rotating blades, such as blade 59, blade 60, and blade 61. Any number of blades may be used. The blades may be mounted onto a rotor wheel 65. The rotor wheel 65 may be attached to the power output drive shaft for rotation therewith. Each stage also may include a number of circumferentially arranged stationary vanes (vanes 67). Any number of the vanes 67 may be used. The vanes 67 may be mounted within an outer casing 70. The outer casing 70 may extend from a bellmouth 75 towards turbine 17. The flow of air 22 enters the compressor 15 about the bellmouth 75 and is compressed through the blades (e.g., blade 59, 60, and 61, among others) and the vanes 67 of the stages before flowing to the combustor.

The gas turbine engine 11 also may include an air extraction system 80. The air extraction system 80 may extract a portion of the flow of air 22 in the compressor 15 for use in cooling the turbine and for other purposes. The air extraction system 80 may include a number of air extraction pipes 85. The air extraction pipes 85 may extend from an extraction port 90 about one of the compressor stages towards one of the stages of turbine 17. FIG. 2 shows an X-stage extraction pipe 92 and a Y-stage extraction pipe 94. The X-stage extraction pipe 92 may be positioned about a ninth stage of compressor 15 and the Y-stage extraction pipe 94 may be positioned about the thirteenth stage of compressor 15. Extractions from other stages of compressor 15 also may be used. The X-stage extraction pipe 92 may be in communication with an X-stage pipe 96 of the turbine while the Y-stage extraction pipe 94 may be in communication with a Y-stage pipe 98 of turbine 17. The X-stage pipe 96 may correspond with a third stage of turbine 17 and the Y-stage pipe 98 may correspond with a second stage of turbine 17, for example.

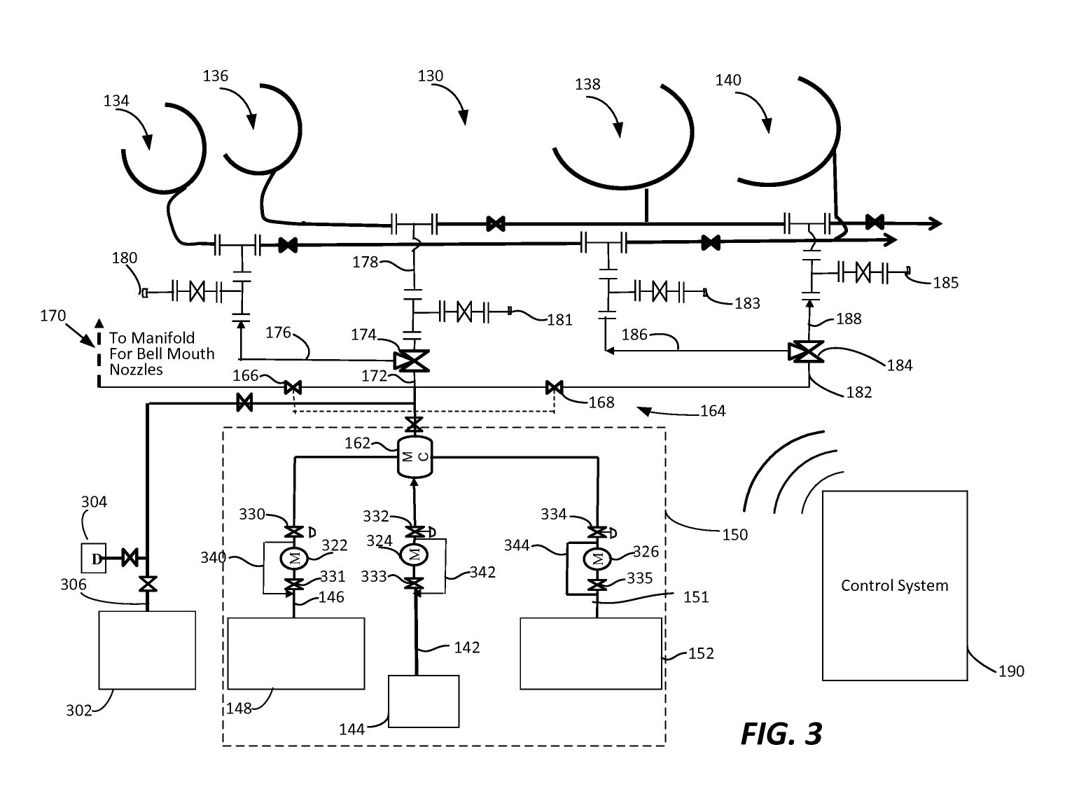

FIG. 3 is a schematic illustration of an exemplary system 130 for dispensing a fluid or otherwise treating for treating a gas turbine engine, such as gas turbine engine 11. In an exemplary embodiment, system 130 is configured for washing or otherwise treating the gas turbine engine when the gas turbine engine is offline or online. Whether the gas turbine is online may be determined based on power output level, but usually includes the gas turbine operating at higher temperatures (e.g., turbine operating above 145° F.). A gas turbine engine may be considered offline when the machine is stop not generating and not connected to the electrical network. A gas turbine may be considered online when the machine is operating at significantly below normal power generating output level. Before an offline wash the gas turbine engine may be cooled down, until the interior volume and surfaces have cooled down sufficiently (e.g., around 145° F.) so that a water or cleaning mixture being introduced into the gas turbine engine will not thermally shock the internal metal and induce creep, or induce any mechanical or structural deformation of the material.

In exemplary system 130, supply piping 150 for water, detergent, or another fluid is connected with existing compressor air extraction piping 134 and extraction piping 136, which may be located near the 9th and 13th compressor stages. Extraction piping 134 and extraction piping 136 may already be present in known gas turbine engine constructions. Turbine cooling piping 138 and turbine cooling piping 140 may be located near the 2nd and 3rd turbine stages and may already be present in known gas turbine engine constructions. The additional piping arrangements in exemplary system 130 may be employed in conjunction with, or as an alternative to, bellmouth nozzles fluidly connected with supply branch 170.

Supply piping 150 includes water supply piping 142 connected with a source 144 of water (e.g., deionized water), as well as detergent (i.e., cleaning agent) supply piping 146 connected with a detergent source 148. Valving (not shown) connected with supply piping 150 may enable selection between different sources of detergent (e.g., for cleaning the compressor 15 versus the turbine 17).

System 130 may include magnesium sulfate piping 151 connected with a supply 152 of water-based magnesium sulfate solution. Magnesium sulfate helps prevent the formation of the vanadium-based slag promoted by the use of crude, heavy oil fuels. Each of water supply piping 142, detergent supply piping 146, and magnesium sulfate supply piping 151 may include a pump. Each pump may have a motor (e.g., motor 322, motor 324, and motor 326), as well as valves (e.g., valve 330, 331, 332, 333, 334, 335), and return flow circuits (e.g., flow circuit 340, flow circuit 342, and flow circuit 344).

Water supply piping 142, detergent supply piping 146, piping 306, and magnesium sulfate supply piping 151 are fluidly connected with mixing chamber 162. From mixing chamber 162, the combined mixture may be directed to mixture supply manifold 164. Control system 190 may determine the ratios of fluids (e.g., between water and anticorrosion agents) to include (or not include). The outflow may be controlled from mixing chamber 162. Manifold 164 includes interlocked valve 166 and valve 168, which, in an exemplary embodiment, are controlled so that only one or the other of valve 166 or valve 168 can be open at any given time (both valves may be closed simultaneously). In an alternative embodiment, valve 166 and valve 168 may be separately and independently controllable. There may be a plurality of mixing chambers connected with a plurality of fluid sources. For example, there may be a mixing chamber dedicated to a source of an anticorrosion fluid (e.g., anticorrosion agent supply 302) and a source of water (e.g., water source 142).

In an embodiment, just water and one or more anticorrosion agents may be mixed in a predetermined ratio. Mixing does not have to occur in the mixing chamber as disclosed herein and the water-anticorrosion agent mixture may be held in a separate storage tank (e.g., a premixed anticorrosion fluid). The mixture for the anticorrosion fluid may be based on the gas turbine engine frame size, duration of wash in combination with discharge, stage the fluid is dispensed in the gas turbine engine (e.g., X-stage of the compressor), or flow requirement. The ratio also may be adjusted based on the type of amine.

System 130 may include piping 306 connected with a supply 302 of an anticorrosion agent. A connection 304 (i.e., a quick disconnect) for external supply (e.g., a truck with an anticorrosion agent) is connected with piping 306.

In an embodiment, just water and one or more anticorrosion agents may be mixed in a predetermined ratio. In an embodiment, anticorrosion agents and other fluids may be mixed via mixing chamber 162 and may be placed into distribution manifold via fluidly connected pipe 306 (there may be several storage or supply units connected with mixing chamber 162). Afterwards, the anticorrosion fluid in supply 302 may be pumped through fluidly connected pipe 306 to the fluidly connected bellmouth nozzles via supply branch 170. Mixing does not have to occur in mixing chamber 162 as disclosed herein and a water-anticorrosion agent mixture, for example, may be held in a separate storage tank (e.g., a premixed anticorrosion fluid may be placed in 302). The mixture for the anticorrosion fluid may be based on the gas turbine engine frame size, duration of wash in combination with discharge, or flow requirement. The ratio also may be adjusted based on the type of amine.

Once mixed and dispersed the anticorrosion fluid may create a molecular layer coating-a micro-coating on metal. Metal passivation imparts a protective shield to metal and/or metal alloy substrates from environmental factors (e.g., high temperatures, combustion by-products, debris, etc.) exhibited in gas turbine engines by forming a coating (e.g., a metal oxide layer) which protects the metal or metal alloy substrate from corrosive species. In an embodiment, the coating that results from the application of the anticorrosion fluid may serve to strengthen the bonds in the metal or metal alloy substrate of a gas turbine engine, such as gas turbine 11. Based on the mixture of the anticorrosion fluid (e.g., type of anticorrosion agent), significant thermal decomposition of the anticorrosion coating may not be exhibited until temperatures above 500° C. is reached. In an embodiment, successive anticorrosion treatment cycles may be applied to the gas turbine engine using the systems described herein, resulting in a multi-layer anticorrosion coating.

Anticorrosion fluid may impart corrosion resistance and/or inhibition to gas turbine engine 11 by using metal passivation to provide an anticorrosion coating on the metal and/or metal alloy substrates in a gas turbine engine with which the anticorrosion mixture comes into contact via the entry points at bellmouth (e.g., supply branch 170 to bellmouth nozzles) in a compressor section, as discussed herein. Resultant anticorrosion fluid (partially or fully) coats stages of compressor section (including the bellmouth) of gas turbine engine and various metallic components therein (e.g., compressor blades and stator vanes).

The anticorrosion fluid may comprise water and an anticorrosion agent in a particularly selected, predetermined ratio. Any anticorrosion agent that is suitable to impart an anticorrosive coating in a gas turbine engine may be employed. In an embodiment, the anticorrosion agent is an organic amine, which acts as a corrosion inhibitor by adsorbing at the metal/metal oxide surface of components in the gas turbine engine, thereby restricting the access of potentially corrosive species (e.g., dissolved oxygen, carbonic acid, chloride/sulfate anions, etc.) to the metal or metal alloy substrate surface of the gas turbine engine component. In an embodiment, the anticorrosion agent is two or more organic amines. In an embodiment, the anticorrosion inhibitor is a polyamine. In an embodiment, anticorrosion treatment may include a combination of polyamine and neutralizing amines.

Valving (not shown) connected with piping 306 may enable selection between different sources of anticorrosion agents or fluids based on application of the fluid to the compressor versus the turbine or some other condition. The anticorrosion fluid may be aerosolized and stored at supply 302 then subsequently applied to turbine 17 or compressor 15 of gas turbine engine 11. In another embodiment, an anticorrosion fluid may be stored in a substantially liquid form, transported through piping, and aerosolized at or near turbine 17 or compressor 11 of a gas turbine engine. Aerosolized anticorrosion fluid may be supplied from an external source, e.g., a truck, and may be manually connected via the quick disconnects as disclosed herein. This aerosolized based anticorrosion fluid can be injected into the turbine section to facilitate anticorrosion protection of the nozzles and buckets after cleaning. For example, gas turbine engines utilizing heavy oil may be treated with vanadium based inhibitor water based magnesium or the like before being treated with the anticorrosion fluid.

The anticorrosion fluid may be mixed automatically at a predetermined ratio (adjustable based on the type of amine) and injected into the bellmouth. Inlet and drain valves may be optimally positioned and aligned prior to introduction of the anticorrosion fluid. The use of the aforementioned access points (e.g., access to stages in the turbine or compressor) instead of just the bellmouth allows for more direct access to the turbine (e.g., turbine 17) and later stages of the compressor (e.g., compressor 15) without depending on the anticorrosion fluid migrating via the combustion system from compressor to turbine section.

From manifold 164, supply branch 170 may provide an anticorrosion fluid to a bellmouth (e.g., bellmouth 75) of a gas turbine engine when the appropriate valves are suitably configured. Similarly, supply line 172 leads to three-way valve 174, which, in turn, leads to supply branch 176 and supply branch 178 to supply a mixture such as the anticorrosion fluid. The mixture in supply branch 176 and supply branch 178 may be supplied simultaneously to piping 134 (e.g., 9th compressor stage air extraction piping) and piping 136 (e.g., 13th compressor stage air extraction piping), respectively. Supply branch 176 and supply branch 178 respectively have a quick disconnect 180 and a quick disconnect 181, which may be employed for distribution of anticorrosion fluids or other fluids. Supply piping 182 extends from manifold 164 to three-way valve 184, and on to supply branch 186 and supply branch 188 to supply a mixture, such as an anticorrosion fluid to piping 138 (e.g., 2nd turbine stage cooling piping) and piping 140 (e.g., 3rd turbine stage cooling piping), respectively. Supply branch 186 and supply branch 188 are provided with quick disconnect 183 and quick disconnect 185, respectively, for use when anticorrosion fluids, or other fluids are employed.

System 130 may incorporate a plurality of sensors (not shown) such as a motor sensor, a fluid level sensor, a fluid pressure sensor, a mixture outflow pressure sensor, a compressor pressure sensor which senses pressure in a compressor section of a gas turbine engine, a turbine pressure sensor which senses pressure in gas turbine engine (e.g., turbine 17), an inlet pressure sensor which senses pressure in supply branch 170 at bellmouth, or valve position sensors (e.g., associated with position of three-way valve 174), among other sensors. System 130 may further include flow sensors configured to sense the rate of flow of a fluid flowing (or not flowing) through piping.

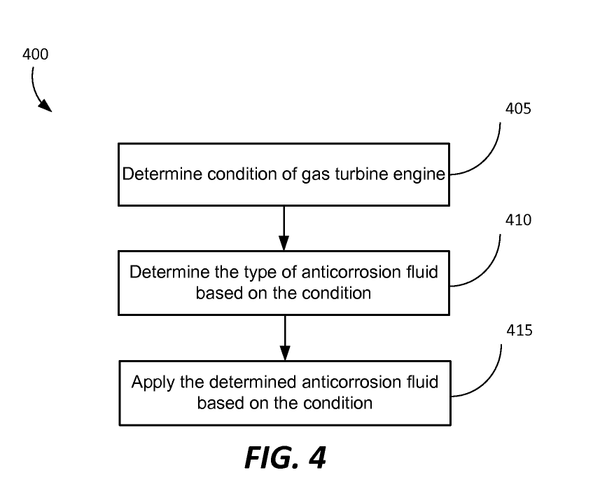

FIG. 4 illustrates a non-limiting, exemplary method 400 of applying a gas turbine engine anticorrosion treatment. In an embodiment at step 405, the condition of the gas turbine engine (e.g., compressor or turbine) may be determined. The condition may be determined based on sensors or the like. The condition may include readiness for the anticorrosion application, such as whether the compressor or turbine is clean, whether a gas turbine engine is in operation (e.g., offline or online), how long the gas turbine engine has been in operation, or temperature of a compressor or turbine, among other things. The condition of whether the gas turbine engine is clean may be determined by data from fouling sensors, the elapsed time between cleanings, or sensors that detect atmospheric conditions during the operation of the gas turbine engine, among other things.

At step 410, the type of anticorrosion fluid to apply to the gas turbine engine may be determined based on the condition of the gas turbine engine. The condition of the gas turbine engine may include the type of gas turbine engine, the amount of damage to the gas turbine engine, the temperature of the gas turbine engine, the power out level of the gas turbine engine, or the like.

At step 415, an anticorrosion fluid may be applied to the gas turbine engine based on the condition of the gas turbine engine. For offline application gas turbine may be cleaned and treated with an approved pre-treatment. If a compressor, turbine, or other gas turbine engine component is dirty when an anticorrosion fluid is applied, the anticorrosion fluid may not bond properly to the gas turbine engine components which in turn, may reduce the effectiveness of the applied anticorrosion fluid. In an embodiment, aerosolized anticorrosion fluid may be applied after cleaning of a gas turbine engine. The cleaning may include one or more of the following: the utilization of a detergent and demineralized water for compressor washing; utilization of an “intra Rinse” solution or pre-passivating treatment followed by a neutralizing rinse; or the utilization of water in combination with magnesium to clean turbine buckets/nozzles in turbines (usually for turbines using heavy fuel oil (HFO) with vanadium treatment).

Although anticorrosion fluid may be substantially heat resistant, a anticorrosion fluid may become ineffective at certain temperatures. Therefore it may be appropriate to apply the anticorrosion fluid at a particular stage of the gas turbine engine component (e.g., compressor or turbine) or not at all based on the temperature at the particular stage. The location of the application of the anticorrosion fluid may be controlled by valves (e.g., three-way valve 174 and three-way valve 184) in communication with a control system (e.g., control system 190), as discussed herein. The valves may be controlled automatically or manually based on a threshold condition (e.g., being above a below a particular temperature).

In an exemplary embodiment, control system 190 communicates, via wireless or hardwire, with the sensors described herein, and further communicates with actuation mechanisms (not shown) provided to start, stop, or control the speed of motors. The control system may open, close, or regulate the position of valves used to accomplish the operations of system 130, as described herein.

Control system 190 may be a computer system that is communicatively connected with a panel/display. Control system 190 may execute programs to control the operation of system 130 using sensor inputs and instructions from human operators. In addition, in an exemplary embodiment, control system 190 may be programmed to alter (or restrict) the ratio of water to polyamine or other anticorrosion agent, alter (or restrict) the cycle times for wash sequences, or alter (or restrict) the order of steps in wash or rinse cycles. Such aspects of the washing method may be selected by a turbine manufacturer to accommodate the specifications and configuration of the turbine being washed.

Control system 190, as shown in FIG. 3, is communicatively connected with power plant systems and devices. Once all the predetermined logic permissive for the application of the anticorrosion fluid has been met, the online distribution of the anticorrosion fluid may become active and the anticorrosion fluid may be appropriately applied. Control system 190 may automatically run the gas turbine engine based on a predetermined/predesigned sequence specifically designed for a anticorrosion fluid dispensing mode. The method for online wash system activation and operation includes determining that the power output and other turbine control parameters have been satisfied for online washing. Control system 190 may attempt to maintain a substantially constant air flow from the compressor to facilitate controlling a fuel to compressor discharge pressure ratio such that a combustor state does not lag changes in airflow during the wash sequence. During operation this system will have the effect of increasing the “mass flow” through the turbine thereby permitting an increase in power delivered to the grid. With the aforementioned in mind, control system 190 may be configured with the appropriate checks and limitations to ensure that it cannot be used excessively (e.g., abused) for power augmentation, NOx abatement, or grid frequency support.

In an embodiment, during the application of the anticorrosion fluid (e.g., via bellmouth nozzles, via an inlet bleed heat system, evaporative cooling system, etc.), control system 190 may be configured to provide instructions to a gas turbine engine to maintain an appropriate power output level. An appropriate power level may be manually set, determined by analysis of the current or similar gas turbine engines, or the like. In an embodiment, excessive use may be minimized by restrictive access to change online fluid application (e.g., anticorrosion fluid) control logic. For example, minimal access to change the anticorrosion agent-water ratio for online application of the anticorrosion fluid, minimal access to change cycle time for online anticorrosion fluid sequences (e.g., between fluid applications), minimal access to change cycle time for online application (e.g., during an fluid application), or the like. Abuse of the online application of fluids or other application of the anticorrosion fluid may be indicated by patterns in the frequency and other data, as suggested herein, with regard to the application of the anticorrosion fluid.

Without in any way limiting the scope, interpretation, or application of the claims appearing herein, a technical effect disclosed herein is the utilization of a combination of chemicals (i.e., corrosion inhibitors) in a ratio of acid and alkaline chemicals in temperature supportive environmental conditions to help the formation of a passivation layer on the surface of gas turbine engine compressor blades and stator vanes. The ratio may be predetermined. Corrosion mitigation may help maintain recovered performance for a longer duration. The application of the corrosion inhibitor may reduce the propensity for compressor blade or turbine blade erosion from numerous water washes. Integrating the anticorrosive distribution system into existing systems, as discussed herein, may minimize a need for new extensive piping runs or casing penetrations.

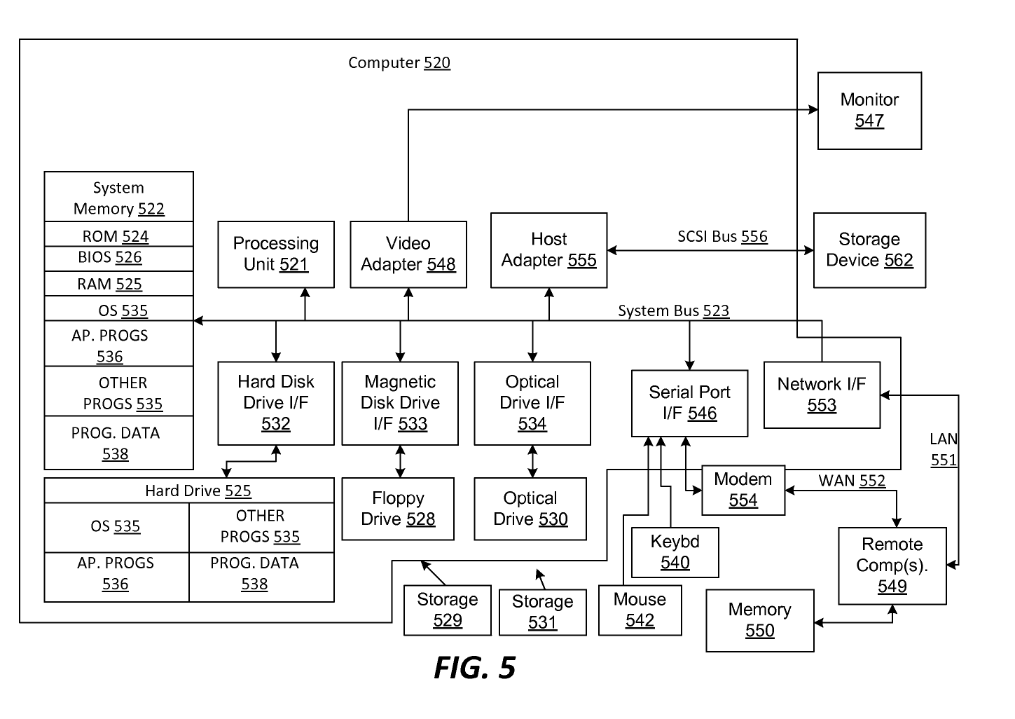

FIG. 5 and the following discussion are intended to provide a brief general description of a suitable computing environment in which the methods and systems disclosed herein and/or portions thereof may be implemented. Although not required, portions of the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

FIG. 5 is a block diagram representing a general purpose computer system in which aspects of the methods and systems disclosed herein and/or portions thereof may be incorporated. As shown, the exemplary general purpose computing system includes a computer 520 or the like, including a processing unit 521, a system memory 522, and a system bus 523 that couples various system components including the system memory to the processing unit 521. The system bus 523 may be any of several types of bus structures including a memory bus or memory controller, a peripheral bus, and a local bus using any of a variety of bus architectures. The system memory includes read-only memory (ROM) 524 and random access memory (RAM) 525. A basic input/output system 526 (BIOS), containing the basic routines that help to transfer information between elements within the computer 520, such as during start-up, is stored in ROM 524.

The computer 520 may further include a hard disk drive 527 for reading from and writing to a hard disk (not shown), a magnetic disk drive 528 for reading from or writing to a removable magnetic disk 529, and an optical disk drive 530 for reading from or writing to a removable optical disk 531 such as a CD-ROM or other optical media. The hard disk drive 527, magnetic disk drive 528, and optical disk drive 530 are connected to the system bus 523 by a hard disk drive interface 532, a magnetic disk drive interface 533, and an optical drive interface 534, respectively. The drives and their associated computer-readable media provide non-volatile storage of computer readable instructions, data structures, program modules and other data for the computer 520. As described herein, computer-readable media is a tangible, physical, and concrete article of manufacture and thus not a signal per se.

Although the exemplary environment described herein employs a hard disk, a removable magnetic disk 529, and a removable optical disk 531, it should be appreciated that other types of computer readable media which can store data that is accessible by a computer may also be used in the exemplary operating environment. Such other types of media include, but are not limited to, a magnetic cassette, a flash memory card, a digital video or versatile disk, a Bernoulli cartridge, a random access memory (RAM), a read-only memory (ROM), and the like.

A number of program modules may be stored on the hard disk, magnetic disk 529, optical disk 531, ROM 524 or RAM 525, including an operating system 535, one or more application programs 536, other program modules 537 and program data 538. A user may enter commands and information into the computer 520 through input devices such as a keyboard 540 and pointing device 542. Other input devices (not shown) may include a microphone, joystick, game pad, satellite disk, scanner, or the like. These and other input devices are often connected to the processing unit 521 through a serial port interface 546 that is coupled to the system bus, but may be connected by other interfaces, such as a parallel port, game port, or universal serial bus (USB). A monitor 547 or other type of display device is also connected to the system bus 523 via an interface, such as a video adapter 548. In addition to the monitor 547, a computer may include other peripheral output devices (not shown), such as speakers and printers. The exemplary system of FIG. 5 also includes a host adapter 555, a Small Computer System Interface (SCSI) bus 556, and an external storage device 562 connected to the SCSI bus 556.

The computer 520 may operate in a networked environment using logical connections to one or more remote computers, such as a remote computer 549. The remote computer 549 may be a personal computer, a server, a router, a network PC, a peer device or other common network node, and may include many or all of the elements described above relative to the computer 520, although only a memory storage device 550 has been illustrated in FIG. 5. The logical connections depicted in FIG. 5 include a local area network (LAN) 551 and a wide area network (WAN) 552. Such networking environments are commonplace in offices, enterprise-wide computer networks, intranets, and the Internet.

When used in a LAN networking environment, the computer 520 is connected to the LAN 551 through a network interface or adapter 553. When used in a WAN networking environment, the computer 520 may include a modem 554 or other means for establishing communications over the wide area network 552, such as the Internet. The modem 554, which may be internal or external, is connected to the system bus 523 via the serial port interface 546. In a networked environment, program modules depicted relative to the computer 520, or portions thereof, may be stored in the remote memory storage device. It will be appreciated that the network connections shown are exemplary and other means of establishing a communications link between the computers may be used.

Computer 520 may include a variety of computer readable storage media. Computer readable storage media can be any available media that can be accessed by computer 520 and includes both volatile and nonvolatile media, removable and non-removable media. By way of example, and not limitation, computer readable media may comprise computer storage media and communication media. Computer storage media include both volatile and nonvolatile, removable and non-removable media implemented in any method or technology for storage of information such as computer readable instructions, data structures, program modules or other data. Computer storage media include, but are not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 520. Combinations of any of the above should also be included within the scope of computer readable media that may be used to store source code for implementing the methods and systems described herein. Any combination of the features or elements disclosed herein may be used in one or more embodiments.

In describing embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. An aerosolized anticorrosion fluid, a vapor anticorrosion fluid, or a non-aerosolized liquid anticorrosion fluid may be implemented via the systems disclosed herein. A fluid as discussed herein is considered a substance that has no fixed shape and yields to external pressure, such as a gas, a liquid, an aerosol, or the like. Although a gas turbine engine for a power plant system is discussed, other similar turbine engine configurations are contemplated herein. The anticorrosion fluid discussed herein may be applied simultaneously or separately via different systems, such as an inlet bleed heat system, an evaporative cooling system, a fogger, a bellmouth nozzle, extraction piping, or other piping and devices depending on the operating condition of the gas turbine—online or offline. Any combination of the features or elements disclosed herein with regard to an anticorrosion fluid may be used in one or more embodiments.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed:

1. A method comprising:
selecting an anticorrosion fluid for a gas turbine engine; and
applying the anticorrosion fluid to the gas turbine engine.

2. The method of claim 1, wherein the anticorrosion fluid is aerosolized.

3. The method of claim 1, wherein the anticorrosion fluid includes a polyamine based fluid.

4. The method of claim 1, wherein the selecting of the anticorrosion fluid for the gas turbine engine is based on a condition of the gas turbine engine.

5. The method of claim 4, wherein the condition of the gas turbine engine is based on at least one of elapsed time between washes, elapsed time between applications of anticorrosion fluid, the gas turbine engine being offline, the gas turbine engine being online, elapsed operation time of the gas turbine engine, temperature of the gas turbine engine, or atmospheric conditions near the gas turbine engine during operation.

6. The method of claim 4, wherein the condition of the gas turbine engine is based on data from a sensor, the sensor comprising at least one of a fouling sensor, a fluid level sensor, a pressure sensor, a temperature sensor, or a flow sensor.

7. The method of claim 1, wherein the anticorrosion fluid was created from combining at least two of the following: cycloheaxylamine, morpholine, monoethanolamine, N-9-Octadecenyl-1,3-propanediamine, 9-octadecen-1-amine, (Z)-1-5, dimethylaminepropylamine (DMPA), or diethylaminoethanol (DEAE).

8. The method of claim 1, further comprising:
maintaining a fuel to compressor discharge pressure ratio of the gas turbine engine so a combustor state does not lag changes in air flow while applying the anticorrosion fluid to the gas turbine engine.

9. A system comprising:
a turbine engine;
a pipe in fluid communication with the turbine engine;
a valve connected with the pipe;
a source of an anticorrosion fluid in fluid communication with the pipe;
a sensor located on or near the turbine engine; and
a control system communicatively connected with the sensor and the valve.

10. The system of claim 9, wherein the turbine engine includes a compressor section or a turbine section.

11. The system of claim 9, wherein the pipe is in fluid communication with compressor section air extraction piping or turbine section air extraction piping.

12. The system of claim 9, further comprising:
a mixing chamber in fluid communication with the source of the anticorrosion fluid.

13. The system of claim 12, further comprising:
a source of water in fluid communication with the mixing chamber.

14. The system of claim 9, wherein the anticorrosion fluid includes water.

15. A system comprising:
a processor adapted to execute computer-readable instructions; and
a memory communicatively coupled to said processor, said memory having stored therein computer-readable instructions that, if executed by the processor, cause the processor to perform operations comprising:
determining a condition of a gas turbine engine;
determining an anticorrosion fluid for the gas turbine engine based on the condition; and
providing instructions to apply the anticorrosion fluid to the gas turbine engine.

16. The system of claim 15, wherein the anticorrosion fluid is aerosolized.

17. The system of claim 15, wherein the anticorrosion fluid includes a polyamine based fluid.

18. The system of claim 15, wherein the condition of the gas turbine engine is based on at least one of elapsed time between washes, elapsed time between applications of anticorrosion fluid, the gas turbine engine being offline, the gas turbine engine being online, elapsed operation time of the gas turbine engine, temperature of the gas turbine engine, or atmospheric conditions of the gas turbine engine during operation.

19. The system of claim 15, wherein the computer-readable instructions executed by the processor cause the processor to effectuate operations further comprising:
determining whether to apply the anticorrosion fluid in an aerosolized form based on the condition of the gas turbine engine.

20. The system of claim 15, wherein the computer-readable instructions executed by the processor cause the processor to effectuate operations further comprising:
determining whether to apply the anticorrosion fluid in an aerosolized form based on a selected component of the gas turbine engine for applying the anticorrosion fluid.
